(19) United States
(12) Patent Application Publication
(10) Pub. No.: US 2004/0241067 A1
(43) Pub. Date: Dec. 2, 2004

(54) Catalyst, method of producing the same and method of treating exhaust gas

(75) Inventors: Yasuyuki Oki, Niihama-shi (JP); Hironobu Koike, Saijo-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/806,411

(22) Filed: Mar. 23, 2004

(30) Foreign Application Priority Data
Mar. 28, 2003 (JP) 2003-090252

(51) Int. Cl. B01J 8/02; B01J 27/198

(52) U.S. Cl. 423/213.2; 502/209

(57) ABSTRACT

A catalyst, a method for producing the same, and a method for treating an exhaust gas are described. The catalyst comprises an oxide containing titanium, vanadium, phosphorus and oxygen. The method of producing a catalyst, comprises the steps of:

(i) spinning a spinning liquid comprising an organic solvent, vanadium, phosphorus and a polymer of a titanium compound, to obtain a precursor,

(ii) calcining the precursor.

The method of treating an exhaust gas comprises a step of contacting an exhaust gas with the catalyst.

### BACKGROUND OF THE INVENTION

1. Field of the Invention

The present invention relates to a catalyst, a method for producing the same, and a method for treating an exhaust gas. More particularly, the present invention relates to a catalyst suitable for treatment of an exhaust gas containing a sulfur oxide, a method for producing the same, and a method for treating an exhaust gas using this catalyst.

2. Description of Related Art

Titanium-vanadium complex oxides are known as a catalyst for treating an exhaust gas (for example, Japanese Patent Application Laid-Open (JP-A) No. 5-184923).

However, conventional catalysts have a problem of decrease in an ability of reducing a nitrogen oxide contained in an exhaust gas (denitration ability) when used for a long period of time for treatment of an exhaust gas.

### SUMMARY OF THE INVENTION

The present inventors have found that a sulfur oxide contained in a combustion exhaust gas lowers a catalytic ability and investigated to develop a catalyst not poisoned by a sulfur oxide, resultantly leading to completion of the present invention.

Namely, the present invention provides a catalyst comprising an oxide containing titanium, vanadium, phosphorus and oxygen.

Also, the present invention provides a method for producing a catalyst, comprising the steps of:

(i) spinning a spinning liquid comprising an organic solvent, vanadium, phosphorus and a polymer of a titanium compound, to obtain a precursor,

(ii) calcining the precursor.

Further, the present invention provides a method for treating an exhaust gas, comprising a step of contacting an exhaust gas with the above-mentioned catalyst.

### BRIEF EXPLANATION OF DRAWING

FIG. 1 shows an X-ray diffraction spectrum of catalyst A obtained in Example 1.

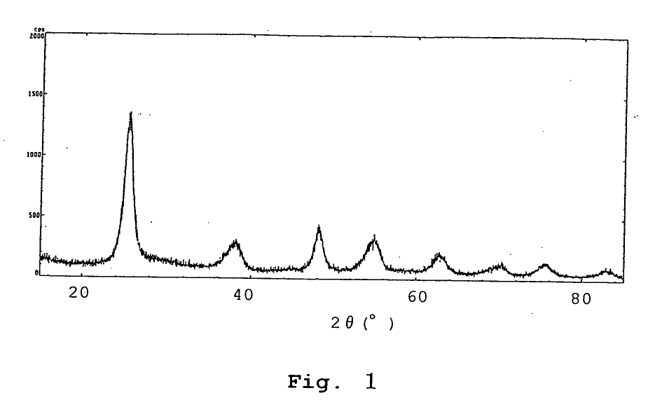

FIG. 2 shows an X-ray diffraction spectrum of catalyst B obtained in Example 2.

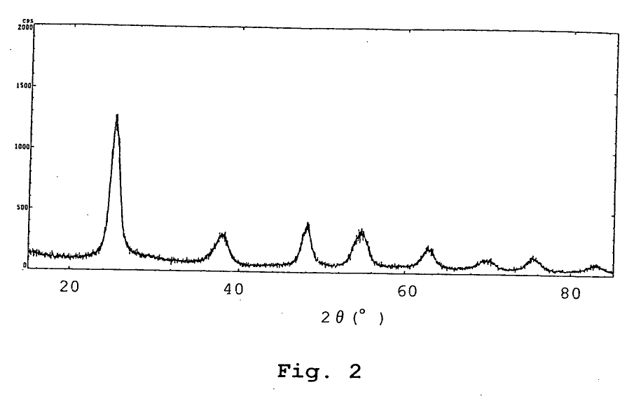

FIG. 3 shows an X-ray diffraction spectrum of catalyst C obtained in Comparative Example 1.

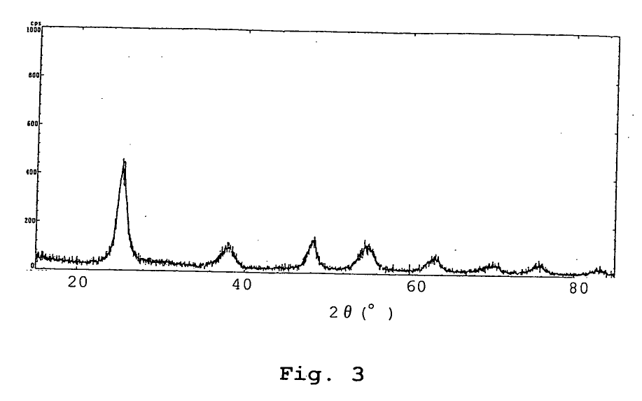

### DETAILED DESCRIPTION OF PREFERRED EMBODIMENTS

### Catalyst According to the Present Invention

The catalyst comprises an oxide containing titanium, vanadium, phosphorus and oxygen.

The weight ratio of titanium and vanadium in terms of oxide (TiO₂/V₂O₅) is usually from 50 wt %/50 wt% to 95 wt %/5 wt %, preferably from 65 wt %/35 wt % to 80 wt %/20 wt %. The phosphorus content, in terms of P₂O₅, is usually about 0.1 part by weight or more, preferably about 1 part by weight or more and usually about 40 parts by weight or less, preferably about parts by weight or less based on the total amount of 100 parts by weight of titanium (in terms of TiO₂) and vanadium (in terms of V₂O₅).

It is preferable that the catalyst comprises titanium oxide having a crystal structure of anatase, and a ratio of titanium oxide having a crystal structure of anatase is about 60% or more in the titanium oxide. Further, it is preferable that the catalyst has a crystallite size of anatase (101) of about 6 nm or more and about 200 nm or less.

It is preferable that when an X-ray diffraction spectrum of the catalyst is measured, the spectrum includes a peak of a titanium oxide and is free from peaks of a vanadium oxide and a phosphorus oxide, and it is more preferable that the spectrum includes a peak of anatase and is free from peaks of a vanadium oxide and a phosphorus oxide.

The catalyst may comprise zirconium, in addition to titanium, vanadium, phosphorus and oxygen. In this case, the zirconia content, in terms of ZrO₂, is usually about 0.1 part by weight or more, preferably about 1 part by weight or more and usually about 40 parts by weight or less, preferably about 10 parts by weight or less based on the total amount of 100 parts by weight of titanium (in terms of TiO₂) and vanadium (in terms of V₂O₅). When zirconium is comprised in the catalyst, it is preferable that when an X-ray diffraction spectrum of the catalyst is measured, the spectrum includes a peak of a titanium oxide and is free from peaks of a vanadium oxide, a phosphorus oxide and a zirconium oxide, and it is more preferable that the spectrum includes a peak of anatase and is free from peaks of a vanadium oxide, a phosphorus oxide and a zirconium oxide.

The catalyst comprises an oxide containing titanium, vanadium, phosphorus and oxygen. This oxide includes at least a single-component oxide selected from the group consisting of Ti—O, V—O and P—O, a binary oxide selected from the group consisting of Ti—V—O, Ti—P—O and V—P—O, or a ternary oxide such as Ti—V—P—O.

When the catalyst comprises zirconium, the oxide comprised in this catalyst includes at least a single-component oxide selected from the group consisting of Ti—O, V—O, P—O and Zr—O, a binary oxide selected from the group consisting of Ti—V—O, Ti—P—O, Ti—Zr—O, V—P—O, V—Zr—O and P—Zr—O, a ternary oxide selected from the group consisting of Ti—V—P—O, Ti—V—Zr—O and V—P—Zr—O, or a 4-components oxide such as Ti—V—P—Zr—O.

The catalyst has an amount of an acid point of usually about 480 μmol/g or more, preferably about 500 μmol/g or more and usually about 800 μmol/g or less.

The catalyst has a BET specific surface area of usually about 10 m²/g or more, preferably about 180 m²/g or more, further preferably about 200 m²/g or more, and about 400 m²/g or less. The catalyst has a total volume of pores (measured by a nitrogen adsorption method) of usually about 0.05 cm³/g or more, preferably about 0.2 cm³/g or more, and a volume of pores having a pore radius of 1 nm or more of usually about 0.02 cm³/g or more, preferably about 0.2 cm³/g or more.

The catalyst is preferably in the form of fiber or sheet.

When the catalyst is in the form of fiber, a diameter (d) of the fiber is usually about 0.1 μm or more, preferably about 2 μm or more and usually about 100 μm or less, preferably about 50 μm or less, its fiber length(L) is usually about 0.2 μm or more, and its aspect ratio(L/d) is about 2 or more. The catalyst in this case may be continuous fiber or short fiber.

When the catalyst is in the form of sheet, a thickness of the sheet is usually about 1 mm or more and about 10 mm or less, and the unit weight is usually about 10 g/m² or more and about 1000 g/m² or less, preferably about 100 g/m² or more and about 500 g/m² or less.

### Method for Producing a Catalyst According to the Present Invention

The method for producing a catalyst comprises steps of (i) and (ii) above-described.

[Preparation of Precursor]

The spinning liquid comprising an organic solvent, vanadium, phosphorus and a polymer of a titanium compound, used in the step (i) may be prepared by

(1) reacting a titanium compound with water in the presence of a vanadium compound, a phosphorus compound, optional zirconium compound and optional additive (described later) to obtain a polymer, and mixing this polymer with an organic solvent, or

(2) reacting a mixture of a titanium compound and optional additive with water to obtain a polymer, and mixing this polymer with a vanadium compound, a phosphorus compound, an organic solvent and optional zirconium compound.

The titanium compound used for preparation of spinning liquid is usually a titanium alkoxide, and the titanium alkoxide includes a compound of the formula (1):

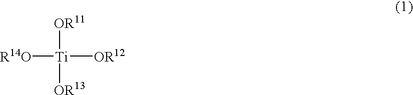

[in the formula (1), R¹¹, R¹², R¹³ and R¹⁴ represent the same or different alkyl]. The titanium alkoxide is preferably one in which R¹¹, R¹², R¹³ and R¹⁴ represent an alkyl having 1 to 4 carbon atoms, and for example, titanium tetramethoxide, titanium tetraethoxide, titanium tetra-n-propoxide, titanium tetraisopropoxide, titanium tetra-n-butoxide, titanium tetra-sec-butoxide and titanium tetra-tert-butoxide are preferable, and titanium tetraisopropoxide is preferable. By using these titanium alkoxides, the mechanical strength of the catalyst (particularly, the catalyst in the form of fiber) increases.

The vanadium compound includes vanadium alkoxide, vanadyl alkoxide, triethoxyvanadyl, vanadium acetylacetonate, vanadium chloride and vanadyl chloride.

The phosphorus compound includes phosphoric ester, acidic phosphoric ester, phosphorous ester, phosphine and phosphine oxide.

The zirconium compound includes zirconium alkoxide such as zirconium tetrabutoxide and zirconium acetylacetonate such as zirconium butoxyacetylacetonate.

The water reacting with a titanium compound includes distilled water, ion exchanged water or the like, and its amount is usually about 1.5 mol or more and about 4 mol or less based on 1 mol of a titanium compound. It is preferable that the water is mixed with an organic solvent (for example, alcohol, ether, aromatic hydrocarbon), before reacting with a titanium compound. By use of the water diluted with an organic solvent, an obtained precursor has more uniform composition. The amount of an organic solvent to be mixed with water is usually about 1 part by weight or more and about 100 parts by weight or less based on 1 part by weight of water.

The reaction may be conducted in the vessel in the presence of an organic solvent. The vessel is preferably equipped with a reflux condenser. The organic solvent includes alcohol such as ethanol and isopropanol, an ether such as tetrahydrofuran and diethyl ether, or an aromatic hydrocarbon such as benzene and toluene. These organic solvents may be used singly or in admixture of two or more. The amount of the organic solvent is usually about 0.5 mol or more and about 50 mol or less based on 1 mol of a titanium compound (it may be an extent causing miscibility of a titanium compound and water). The gas phase in the vessel may usually be filled with an inert gas such as N₂ and Ar.

The lower limit of the reaction temperature is usually 0° C., and the upper limit thereof is either the boiling point of an organic solvent or the boiling point of water.

The reaction is preferably conducted in the presence of a compound of the formula (2) in addition to the above-described organic solvent:

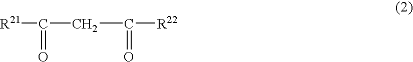

[in the formula (2), R²¹ and R²² represent the same or different alkyl or alkoxy]. R²¹ and R²² represent an alkyl having 1 to 4 carbon atoms such as methyl, ethyl, n-propyl, n-butyl, isobutyl, sec-butyl and tert-butyl; or an alkoxyl having 1 to 4 carbon atoms such as ethoxy, n-propoxy, isopropoxy, n-butoxy, isobutoxy, sec-butoxy and tert-butoxy. The compound of the formula (2) includes β-diketone compound such as ethyl acetoacetate and isopropyl acetoacetate. Its amount is usually about 0.01 mol or more, preferably about 0.05 mol or more and usually about 1.9 mol or less, preferably about 1 mol or less, based on 1 mol of a titanium compound.

The reaction may be conducted in the presence of an alkyl salicylate in addition to the above-described organic solvent or a compound of the formula (2). The alkyl salicylate includes methyl salicylate or ethyl salicylate. Its amount is usually about 0.01 mol or more, preferably about 0.05 mol or more and usually about 1.9 mol or less, preferably about 1 mol or less, based on 1 mol of a titanium compound.

By the above-mentioned reaction, a titanium compound is hydrolyzed and polymerized to obtain a liquid comprising a polymer, organic solvent, vanadium, phosphorus and optional zirconium.

Usually, an organic solvent (for example, alcohol) and water are removed from the liquid by separation, to obtain a mixture comprising a polymer, vanadium, phosphorus and optional zirconium. Separation may be conducted by distillation and the like.

By adding an organic solvent, and if necessary, a fatty acid, to the obtained mixture, spinning liquid is obtained. The organic solvent added in this case includes ethers such as tetrahydrofuran and diethyl ether, and aromatic hydrocarbons such as benzene and toluene. When preparation of spinning liquid used in the step (i) is conducted by the above-mentioned method (2) “by reacting a mixture of a titanium compound and optional additive with water to obtain a polymer, and mixing this polymer with a vanadium compound, a phosphorus compound, an organic solvent and optional zirconium compound”, the organic solvent includes preferably one dissolving a polymer, vanadium compound and phosphorus compound, and tetrahydrofuran is more preferable as the organic solvent. The amount of the organic solvent is usually about 20 parts by weight or more and about 50 parts by weight or less based on 100 parts by weight of spinning liquid. The fatty acid added to the mixture includes a compound of the formula (3):

R³COOH (3)

[in the formula (3), R³ represents a hydrogen atom, saturated hydrocarbon residue or unsaturated hydrocarbon residue], and preferably, R³ represents a saturated hydrocarbon residue or unsaturated hydrocarbon residue having 8 or more carbon atoms. Preferable examples of the fatty acid includes saturated fatty acid such as formic acid, acetic acid, propionic acid, butyric acid, isobutyric acid, valeric acid, capronic acid, enanthic acid, caprylic acid, pelargonic acid, capric acid, undecylic acid, lauric acid, tridecylic acid, myristic acid, pentadecylic acid, palmitic acid, heptadecylic acid, stearic acid, isostearic acid, nonadecanoic acid, arachic acid, behenic acid, lignoceric acid, cerotic acid, heptacosanic acid, montanic acid, melissic acid and lacceric acid; and unsaturated fatty acid such as acrylic acid, crotonic acid, isocrotonic acid, undecylenic acid, oleic acid, elaidic acid, setoleic acid, erucic acid, brassidic acid, sorbic acid, linolic acid, linolenic acid, arachidonic acid, propiolic acid and stearolic acid. The amount of the fatty acid is usually 0.01 mol or more, preferably 0.05 mol or more and usually 0.5 mol or less, preferably 0.3 mol or less per mol of titanium (Ti) in a polymer.

The obtained spinning liquid has a viscosity of usually 1 Pa·s or more, preferably 2 Pa·s or more and usually 20 Pa·s or less, preferably 15 Pa·s or less. The viscosity of the spinning liquid may be regulated by changing the amount of an organic solvent added to the polymer or the temperature of the spinning liquid.

The precursor may be prepared by spinning the spinning liquid. Spinning may be conducted by, for example, a nozzle extrusion method, centrifugal method or blowing method. In spinning, fiber obtained by spinning may be drawn. Drawing may be conducted by using a rotation roller, air flow, and the like.

The precursor may be treated with steam in a thermo-hydrostat. The conditions thereof includes a temperature of usually about 70° C. or more, preferably about 85° C. or more and about 300° C. or less, a time of usually about 1 hour or more, preferably about 5 hours or more and about 30 hours or less, a partial pressure of water vapor of usually about 0.03 MPa or more, preferably about 0.05 MPa or more and not more than the saturated pressure of water vapor at the steam treatment temperature.

[Production of Catalyst]

In the above-described step (2), the precursor obtained by step (1) is calcined. The calcination may be conducted at about 200° C. to 900° C., for about 0.5 hours to 3 hours. The calcination may be conducted while applying tension on a precursor. The obtained catalyst may be usually continuous fiber, and if necessary, cut or formed into short fiber, sheet or the like. Short fiber may be produced by, for example, a blowing method, spinning method. Sheet may be produced by, for example, a paper making method.

### Method of treating Exhaust Gas According to the Present Invention

The method for treating an exhaust gas comprises a step of contacting an exhaust gas with the above-described catalyst. Contacting the catalyst with a gas may be conducted by, for example, a method of putting a catalyst in a reactor, introducing a gas into the reactor. Treatment temperature is usually about 150° C. to 900° C. The treated exhaust gas is, for example, a combustion exhaust gas from a thermal power station and an incinerator, and it comprises a nitrogen oxide (NOx) or organic halide. The treated exhaust gas may additionally comprise sulfur oxide, N₂, O₂, CO₂, or the like.

### EXAMPLES

The present invention will be illustrated more in detail by examples below, but the scope of the invention is not limited to these examples. The properties of catalyst were measured by the following methods.

(I) Peak of Oxide (TiO₂, V₂O₅, P₂O₅, ZrO₂) in X-ray Diffraction Spectrum, Main Crystal Phase:

A catalyst was pulverized with a mortar and its X-ray diffraction spectrum was measured by using an X-ray diffractometer (trade name “RAD-IIA”, manufactured by Rigaku Denki K. K.). From this spectrum, the peak intensity of each crystal phase of TiO₂ was obtained. Also regarding crystal phase of V₂O₅, P₂O₅ and ZrO₂, the peak intensity of each phase was obtained. A relative intensity of crystal phase of oxide was calculated from the peak intensity, a crystal phase having highest relative intensity was recognized as the main crystal phase.

(II) Degree of Anatase Crystallinity:

From the X-ray diffraction spectrum measured in the above-mentioned procedure (II), the area Si of the peak of an anatase (101) plane was obtained. As the standard sample, anatase (trade name “STT-65C-S”, manufactured by Titan Kogyo K. K.) was used, and the X-ray diffraction spectrum of this anatase was measured at the same conditions, to obtain the area S₂ of the peak of an anatase (101) plane.

For correcting the titanium content of a catalyst, the titanium content x (mol fraction), in terms of metal element, of the catalyst was obtained, and ratio A (%) of anatase was calculated according to the formula (4):

A=S₁/(S₂·x) (4)

(III) Anatase Crystallite Size:

From the X-ray diffraction spectrum measured in the above-mentioned procedure (II), a full width at half maximum β (radian) of an anatase type titanium oxide (101) plane and a peak position θ (radian) of the (101) plane were obtained, and the crystallite size L (nm) was calculated according to the formula (5):

L=K·λ/(β·cos θ) (5)

[in the formula (5), K represents a Scherrer's constant (0.94), λ (nm) represents an X-ray wavelength (CuKα line: 0.15406 nm)].

(IV) Amount of Acid Point:

0.1 g of a catalyst and 0.4 g of glass beads were mixed, the mixture was charged into a cell, and under vacuum, the temperature thereof was raised at a rate of 20° C./minute up to 350° C., kept at the same temperature for 1 hour, then, the catalyst was allowed to contact with an ammonia gas of 0.013 MPa at 100° C. for 30 minutes, for adsorption of ammonia. Then, the ammonia gas was discharged at 100° C. for 30 minutes, then, the temperature thereof was raised at a rate of 10° C./minute from 100° C. while charging a helium gas at a rate of 20 Ncm³/minute into a cell. During this procedure, ammonia desorbing from the catalyst was quantified by a quadrupole mass spectroscopy to measure the adsorption amount (μmol) of ammonia, and the ammonia adsorption amount per g of the catalyst was shown as the amount (μmol/g) of acid points.

(V) BET Specific Surface Area, Total Pore Volume, Volume of Pores Having Pore Radius of 1 nm or More:

These values were calculated from a distribution curve of pore volumes against pore radii, which was obtained by nitrogen continuous volume method using a gas adsorption/desorption analyzer (trade name “Omnisorp 360” manufactured by Coulter Co., Ltd.). In this method, a catalyst was degassed under conditions including a temperature of 130° C., a retention time of 6hours and a vacuum of 8 mPa after pulverizing in a mortar.

(VI) Catalytic Ability:

A test piece (catalyst in the form of sheet) was sandwiched by two felts (trade name “P—84”, manufactured by Toyobo Co., Ltd), and fixed onto inside of a reactor.

Into the reaction, a NOx-containing gas (NOx: 100 ppm, NH₃: 100 ppm, O₂: 10 vol %, H₂O: 20 vol %, 20 vol %, residue: nitrogen) was fed under conditions of a temperature of 200° C. and a linear velocity of 1.0 m/minute, and the NOx concentration C₀ at the inlet of the reaction tube and the NOx concentration C₁ at the outlet of the reaction tube were measured using a nitrogen oxide concentration automatic measuring apparatus (trade name: “ECL-77A type”, manufactured by Yanagimoto Seisakusho K.K.), and the denitration ratio R_{NOX}⁰ of the catalyst before contact with a SOx gas calculated according to the formula (6):

Denitration ratio R_{NOx} (%)=(C₀-C₁)/C₀×100 (6)

Next, into the reaction tube, a SOx-containing gas (SO₂: 500 ppm, O₂: 10 vol %, H₂O: 20 vol %, residue: nitrogen) was fed under conditions of a temperature of 170° C. and a flow rate of 1 NL/minute for 24 hours, to allow the catalyst to contact the SOx-containing gas. The Denitration ratio R_{NOx}¹ of this catalyst was obtained under the same conditions as described above.

### Example 1

[Preparation of Precursor]

To 63.9 g of isopropyl alcohol (guaranteed reagent, manufactured by Wako Pure Chemical Industries Ltd.) was added 225 g of titanium tetraisopropoxide (chemical reagent, manufactured by Wako Pure Chemical Industries Ltd.), 61.9 g of vanadium isopropoxide (manufactured by Nichia Kagaku Kogyo K.K.), 11.5 g of triethyl phosphate (manufactured by Tokyo Kasei Kogyo K.K.), 7.6 g of an n-butanol solution (manufactured by Research Chemicals) having a zirconium n-butoxide concentration of 80 wt % and 5.2 g of ethyl acetoacetate (guaranteed reagent, manufactured by Wako Pure Chemical Industries Ltd.), then, the mixture was heated for 1 hour under a nitrogen atmosphere while refluxing, to obtain a titanium alkoxide solution. The weight ratio in titanium, vanadium, phosphorus and zirconium in the resulted titanium alkoxide solution was 68:25:4.9:2.1 in terms of oxide. The amount of ethyl acetoacetate was 0. 05 mol per mol of titanium tetraisopropoxide.

32.7 g of water and 294.9 g of isopropyl alcohol were mixed, to obtain an alcohol solution having a water concentration of 10 wt %. The water amount contained in the alcohol solution was 2.3 mol per mol of titanium tetraisopropoxide.

The titanium alkoxide solution obtained above was placed into a vessel equipped with a reflux condenser, and heated at the reflux temperature under a nitrogen atmosphere while stirring, then, the alcohol solution obtained above was added to this, to obtain a slurry containing a polymer. During this procedure, the feed rate of the alcohol solution was regulated so that the alcohol amount contained in the alcohol solution added coincided with the alcohol distillation amount. When the water amount contained in the alcohol solution added reached 1.8 mol per mol of titanium tetraisopropoxide, deposition of the polymer initiated. The duration from the initiation of addition of the alcohol solution until completion thereof was 116 minutes.

The slurry was heated at the reflux temperature for 1 hour under a nitrogen atmosphere while stirring without distilling alcohol, then, further heated to distill alcohol, obtaining a concentrated slurry having a titanium concentration (in terms of metal element) of 3.04×10⁻³ mol/g.

The concentrated slurry and 265 g of tetrahydrofuran (guaranteed reagent, manufactured by Wako Pure Chemical Industries Ltd.) were heated at the reflux temperature for 1 hour under a nitrogen atmosphere, to dissolve the polymer contained in the concentrated slurry in tetrahydrofuran, then, 22.5 g of isostearic acid (guaranteed reagent, manufactured by Wako Pure Chemical Industries Ltd.) was added. The resulted mixture was heated at the reflux temperature for 1 hour under a nitrogen atmosphere, to obtain the polymer solution.

The polymer solution was filtrated using a membrane filter made of a fluorine resin having a pore diameter of 3 μm under a nitrogen atmosphere. The filtrate was heated, and solvents (isopropyl alcohol and tetrahydrofuran) were distilled off from the filtrate, to obtain 221 g of spinning liquid. This spinning liquid had a viscosity of 5 Pa·s at 40° C.

The spinning liquid regulated at 40° C. was extruded into air having a temperature of 40° C. and a relative humidity of 60% using a nitrogen gas (pressure: 2 MPa) from a nozzle having a pore diameter of 50 μm. The fiber discharged from the nozzle was wound at a rate of 70 m/minute, to obtain a precursor in the form of fiber.

[Production of Catalyst]

The obtained precursor was placed into a thermo-hydrostat having a temperature of 85° C. and a relative humidity of 95% (partial pressure of water vapor: 0.054 MPa), and treated with moisture for 15 hours. Then, the precursor was heated at a rate of 50° C./hour up to 400° C. under air and calcinated at 400° C. for 1 hour, to obtain a catalyst A. The properties of the catalyst A are shown in Table 1-1 and Table 1-2.

[Production of Catalyst in the form of Sheet]

To 1 L of water was added 5.46 g of para-amide pulp (trade name: “TWARON 1094”, manufactured by Nippon Aramide K.K.), 0.57 g of lauryldimethylaminoacetic acid betaine (trade name: “UNHITOL 24B”, content: 26 wt %, manufactured by Kao Corp.), 0.5 g of a defoaming agent (trade name: “HOMELESS P-98”, manufactured by Meisei Kagaku Kogyo K.K.) and 7.28 g of the catalyst A obtained above, in this order, then, they were mixed using a pulp disaggregation apparatus (type number “No. 2529”, manufactured by Kumagaya Riki Kogyo K.K.), further, 17 L of water was added. The resulted mixed liquid was fed to a paper manufacturing machine (type number “Angle Type Sheet Machine No. 2555”, manufactured by Kumagaya Riki Kogyo K.K.) to produce a wet sheet, and this was dehydrated and dried, to obtain a catalyst in the form of sheet having a unit weight of 152 g/m², a thickness of 1 mm, a longitudinal length of 250 mm and a transversal length of 250 mm. This catalyst in the form of sheet was cut to obtain a circular test piece having a diameter of 53 mm of which denitration ability was evaluated. The results are shown in Table 2.

### Example 2

To 71.5 g of isopropyl alcohol (guaranteed reagent, manufactured by Wako Pure Chemical Industries Ltd.) was added 225 g of titanium tetraisopropoxide (chemical reagent, manufactured by Wako Pure Chemical Industries Ltd.), 61.9 g of vanadium isopropoxide (manufactured by Nichia Kagaku Kogyo K.K.), 11.5 g of triethyl phosphate (manufactured by Tokyo Kasei Kogyo K.K.) and 5.2 g of ethyl acetoacetate (guaranteed reagent, manufactured by Wako Pure Chemical Industries Ltd.), then, the mixture was heated for 1 hour under a nitrogen atmosphere while refluxing, to obtain a titanium alkoxide solution. The weight ratio in titanium, vanadium and phosphorus in the resulted titanium alkoxide solution was 70:25:5 in terms of oxide.

32.7 g of water and 294.9 g of isopropyl alxohol were mixed, to obtain an-alcohol solution having a water concentration of 10 wt %.

The titanium alkoxide solution obtained above was placed into a vessel equipped with a reflux condenser, and heated at the reflux temperature under a nitrogen atmosphere while stirring, then, the alcohol solution obtained above was added to this, to obtain a slurry containing a polymer. During this procedure, the feed rate of the alcohol solution was regulated so that the alcohol amount contained in the alcohol solution added coincided with the alcohol distillation amount. When the water amount contained in the alcohol solution added reached 1.8 mol per mol of titanium tetraisopropoxide, deposition of the polymer initiated. The duration from the initiation of addition of the alcohol solution until completion thereof was 116 minutes.

The slurry was heated at the reflux temperature for 1 hour under a nitrogen atmosphere while stirring without distilling alcohol, then, further heated to distill alcohol, obtaining a concentrated slurry having a titanium concentration (in terms of metal element) of 5.22×10⁻³ mol/g.

The concentrated slurry and 269 g of tetrahydrofuran (guaranteed reagent, manufactured by Wako Pure Chemical Industries Ltd.) were heated at the reflux temperature for 1 hour under a nitrogen atmosphere, to dissolve the polymer contained in the concentrated slurry in tetrahydrofuran, then, 22.5 g of isostearic acid (guaranteed reagent, manufactured by Wako Pure-Chemical Industries Ltd.) was added. The resulted mixture was heated at the reflux temperature for 1 hour under a nitrogen atmosphere, to obtain the polymer solution.

The polymer solution was filtrated using a membrane filter made of a fluorine resin having a pore diameter of 3 μm under a nitrogen atmosphere. The filtrate was heated, and solvents (isopropyl alcohol and tetrahydrofuran) were distilled off from the filtrate, to obtain 221 g of spinning liquid. This spinning liquid had a viscosity of 5 Pass at 40° C.

The spinning liquid regulated at 40° C. was extruded into air having a temperature of 40° C. and a relative humidity of 60% using a nitrogen gas (pressure: 2 MPa) from a nozzle having a pore diameter of 50 μm. The fiber discharged from the nozzle was wound at a rate of 70 m/minute, to obtain a precursor in the form of fiber.

A catalyst B was obtained from the resulted precursor by conducting the same operation [Production of catalyst] as in Example 1. The properties of the catalyst B are shown in Table 1-1 and Table 1-2. Further, a catalyst in the form of sheet was obtained by conducting the same operation [Production of catalyst sheet] as in Example 1. This catalyst was cut to obtain a circular test piece having a diameter of 53 mm of which denitration ability was evaluated. The results are shown in Table 2.

### Comparative Example 1

To 94.1 g of isopropyl alcohol (guaranteed reagent, manufactured by Wako Pure Chemical Industries Ltd.) was added 225 g of titanium tetraisopropoxide (chemical reagent, manufactured by Wako Pure Chemical Industries Ltd.), 70.1 g of vanadium isopropoxide (manufactured by Nichia Kagaku Kogyo K.K.) and 5.84 g of ethyl acetoacetate (guaranteed reagent, manufactured by Wako Pure Chemical Industries Ltd.), then, the mixture was heated for 1 hour under a nitrogen atmosphere while refluxing, to obtain a titanium alkoxide solution. The weight ratio in titanium and vanadium in the resulted titanium alkoxide solution was 73:27 in terms of oxide. The amount of ethyl acetoacetate was 0.05 mol per mol of titanium tetraisopropoxide.

37 g of water and 334 g of isopropyl alxohol were mixed, to obtain an alcohol solution having a water concentration of 10 wt %. The water amount contained in the alcohol solution was 2.3 mol per mol of titanium tetraisopropoxide.

The titanium alkoxide solution obtained above was placed into a vessel equipped with a reflux condenser, and heated at the reflux temperature under a nitrogen atmosphere while stirring, then, the alcohol solution obtained above was added to this, to obtain a slurry containing a polymer. During this procedure, feed rate of the alcohol solution was regulated so that the alcohol amount contained in the alcohol solution added coincided with the alcohol distillation amount. When the water amount contained in the alcohol solution added reached 1.8 mol per mol of titanium tetraisopropoxide, deposition of the polymer initiated. The duration from the initiation of addition of the alcohol solution until completion thereof was 116 minutes.

The slurry was heated at the reflux temperature for 1 hour under a nitrogen atmosphere while stirring without distilling alcohol, then, further heated to distill alcohol, obtaining a concentrated slurry having a titanium concentration (in terms of metal element) of 3.07×10⁻³ mol/g.

The concentrated slurry and 271 g of tetrahydrofuran (guaranteed reagent, manufactured by Wako Pure Chemical Industries Ltd.) were heated at the reflux temperature for 1 hour under a nitrogen atmosphere, to dissolve the polymer contained in the concentrated slurry in tetrahydrofuran, then, 22.5 g of isostearic acid (guaranteed reagent, manufactured by Wako Pure Chemical Industries Ltd.) was added. The resulted mixture was heated at the reflux temperature for 1 hour under a nitrogen atmosphere, to obtain the polymer solution.

The polymer solution was filtrated using a membrane filter made of a fluorine resin having a pore diameter of 3 μm under a nitrogen atmosphere. The filtrate was heated, and solvents (isopropyl alcohol and tetrahydrofuran) were distilled off from the filtrate, to obtain 262 g of spinning liquid. This spinning liquid had a viscosity of 5 Pa·s at 40° C.

The spinning liquid regulated at 40° C. was extruded into air having a temperature of 40° C. and a relative humidity of 60% (partial pressure of water vapor: 0.0044 MPa) using a nitrogen gas (pressure: 2 MPa) from a nozzle having a pore diameter of 50 μm. The fiber discharged from the nozzle was wound at a rate of 70 m/minute, to obtain a precursor in the form of fiber.

The obtained precursor was placed into a thermo-hydrostat having a temperature of 85° C. and a relative humidity of 95%, and treated with moisture for 15 hours. Then, the precursor was heated at a rate of 200° C./hour up to 350° C. under air and calcinated at 350° C. for 1 hour, to obtain a catalyst C. The properties of the catalyst C are shown in Table 1-1 and Table 1-2.

To 1 L of water was added 5.43 g of para-amide pulp (trade name: “TWARON 1094”, manufactured by Nippon Aramide K.K.) 0.55 g of lauryldimethylaminoacetic acid betaine (trade name: “UNHITOL 24B”, content: 26 wt %, manufactured by Kao Corp.), 0.55 g of a defoaming agent (trade name: “HOMELESS P—98”, manufactured by Meisei Kagaku Kogyo K.K.) and 7.28 g of the catalyst C obtained above, in this order, then, they were mixed using a pulp disaggregation apparatus (type number “No. 2529”, manufactured by Kumagaya Riki Kogyo K.K.), further, 17 L of water was mixed. The resulted mixed liquid was fed to a paper manufacturing machine (type number “Angle Type Sheet Machine No. 2555”, manufactured by Kumagaya Riki Kogyo K.K. ) to produce a wet sheet, and this was dehydrated and dried, to obtain a catalyst in the form of sheet having a unit weight of 151 g/m², a thickness of 1 mm, a longitudinal length of 250 mm and a transversal length of 250 mm. This catalyst in the form of sheet was cut to obtain a circular test piece having a diameter of 53 mm of which denitration ability was evaluated. The results are shown in Table 2.

TABLE 1-1

| | Content (wt %) | | | | Peak in XRD spectrum | | | |
|---|---|---|---|---|---|---|---|---|
| | TiO₂ | V₂O₅ | P₂O₅ | ZrO₂ | TiO₂ | V₂O₅ | P₂O₅ | ZrO₂ |
| Catalyst A | 68 | 25 | 4.9 | 2.1 | Present | None | None | None |
| Catalyst B | 70 | 25 | 5 | 0 | Present | None | None | None |
| Catalyst C | 73 | 27 | 0 | 0 | Present | None | None | None |

TABLE 1-2

| | | Catalyst | Catalyst | Catalyst |
|---|---|---|---|---|
| | | A | B | C |
| Main crystal phase | | Anatase | Anatase | Anatase |
| Degree of anatase | % | 77 | 76 | 71 |
| crystallinity | | | | |
| Anatase | nm | 7.2 | 6.6 | 6.3 |
| crystallite size | | | | |
| Amount of acid | μmol/g | 571 | 540 | 462 |
| point | | | | |
| BET specific | m²/g | 241 | 213 | 215 |
| surface area | | | | |
| Pore volume | | | | |
| Total | cm³/g | 0.3 | 0.28 | 0.18 |
| Having radius | cm³/g | 0.3 | 0.28 | 0.18 |
| of 1 nm or more | | | | |

TABLE 2

Denitration ratio (%)

| | R_{NOX}⁰ before contact | R_{NOX}¹ after contact |
|---|---|---|
| | with SO_{X} | with SO_{X} |
| Example 1 | 65 | 55 |
| Example 2 | 65 | 51 |
| Comparative | 66 | 47 |
| example 1 | | |

1. A catalyst comprises an oxide containing titanium, vanadium, phosphorus and oxygen.

2. The catalyst according to claim 1, the catalyst further comprises zirconium.

3. The catalyst according to claim 1 wherein when an X-ray diffraction spectrum is measured, the spectrum includes a peak of a titanium oxide and is free from peaks of a vanadium oxide and a phosphorus oxide.

4. The catalyst according to claim 2 wherein when an X-ray diffraction spectrum is measured, the spectrum includes a peak of a titanium oxide and is free from peaks of a vanadium oxide, a phosphorus oxide and a zirconium oxide.

5. The catalyst according to any of claims 1 to 4, wherein the catalyst is in the form of fiber or sheet.

6. A method of producing a catalyst, comprises the steps of:
(i) spinning a spinning liquid comprising an organic solvent, vanadium, phosphorus and a polymer of a titanium compound, to obtain a precursor,
(ii) calcining the precursor.

7. The method according to claim 6, wherein the spinning liquid further comprises zirconium.

8. A method of treating an exhaust gas, comprises a step of contacting an exhaust gas with a catalyst according to any of claims 1 to 4.

9. The method according to claim 8, wherein the exhaust gas comprises a nitrogen oxide or an organic halide.

10. The method according to claim 9, wherein the exhaust gas additionally comprises sulfur oxide.

11. A method of treating an exhaust gas, comprises a step of contacting an exhaust gas with a catalyst according to claim 5.

12. The method according to claim 11, wherein the exhaust gas comprises a nitrogen oxide or an organic halide.

13. The method according to claim 12, wherein the exhaust gas additionally comprises sulfur oxide.
